(19) United States
(12) Patent Application Publication
(10) Pub. No.: US 2017/0271981 A1
(43) Pub. Date: Sep. 21, 2017

(54) VOLTAGE CONTROL IN A CONVERTER SUPPLYING POWER TO A LOAD

(71) Applicant: Telefonaktiebolaget LM Ericsson (publ), Stockholm (SE)

(72) Inventors: Magnus Karlsson, Oskarshamn (SE); Jonas Malmberg, Farjestaden (SE); Fredrik Wahledow, Farjestaden (SE)

(73) Assignee: Telefonaktiebolaget LM Ericsson (publ), Stockholm, SE (SE)

(21) Appl. No.: 15/119,242

(22) PCT Filed: Sep. 29, 2015
(86) PCT No.: PCT/SE2015/051023

§ 371 Date: Aug. 16, 2016

(51) Int. Cl. H02M 3/04; H02M 7/44; H02M 5/04; H02M 7/04

(52) U.S. Cl. CPC H02M 3/04; H02M 7/04; H02M 7/44; H02M 5/04

(57) ABSTRACT

A converter control unit, method, and computer program product for controlling a power supply device including a converter that provides power to a load. In one embodiment, the converter control unit is configured to obtain a load voltage measure from the converter representing a load voltage of the load, obtain an estimate of a voltage drop between the converter and the load, and obtain a reference voltage corresponding to a desired load voltage. The converter control unit is also configured to adjust the reference voltage or the load voltage measure with the estimate of the voltage drop, and compare, after the adjustment, the load voltage measure with the reference voltage to acquire an error signal. The converter control unit is still further configured to control the converter to provide the load voltage based on the error signal.

### TECHNICAL FIELD

The present invention relates to the field of load power supply. The invention more particularly relates to a converter control device, method, computer program and computer program product for controlling power supply by a converter to a load

### BACKGROUND

Power supply devices, such as Switch Mode Power Supplies (SMPS) may be provided for a variety of loads.

Power supply devices may for instance be provided for high-performance Ultra large-scale integration (ULSI) circuits (e.g. processors, application-specific integrated circuits (ASICs) and Field-Programmable Gate Arrays (FPGAs)).

A power supply device is then typically provide through a converter which is controlled to deliver power to a load using a converter control unit, for instance a PID based converter control unit that delivers pulse width modulation (PWM) pulses for controlling the converter. The converter control unit then adjusts the supplied power based on the load voltage. In doing this the voltage at the load is measured and feed back to the control circuit.

There is a problem with this realization in that the load may comprise several subloads, which makes it difficult to measure the voltages at all the different subloads. Furthermore the circuit that implements the power supply device would require at least two connection points, such as pins or pads, for receiving such load voltage measurements.

It would therefore be of interest to obtain a power supply device that is simpler both regarding the load voltage measuring as well as with regard to the number of connection points used.

Active droop is a control methology that has been used for active voltage positioning in order to decrease a voltage transient or for paralleling of SMPS, see Huang, W., Abu Qahouq, J. A.; Ahmed, S., “Linearized sensorless adaptive voltage positioning controller for DC-DC boost power converter,” Energy Conversion Congress and Exposition (ECCE), 2012 IEEE, pp. 351-357, 15-20 Sep. 2012.

### SUMMARY

One object is to provide a simpler power control device.

This object is according to a first aspect achieved through a power supply device for controlling power supply by a converter to a load. The power supply device comprises a converter control unit, which in turn comprises a processor and memory. The memory contains computer instructions executable by the processor whereby the converter control unit:

obtain s a measure of the load voltage as a voltage at the converter,

obtains an estimate of a voltage drop between the converter and the load,

obtain a reference voltage corresponding to a desired load voltage,

adjust either the reference voltage or the load voltage measure with the voltage of the estimated voltage drop,

compare, after the adjustment, the load voltage measure with the reference voltage for obtaining an error signal, and

control the converter to provide the load voltage based on the error signal.

The object is according to a second aspect achieved through a method for controlling a converter supplying power to a load.

The method is performed in a converter control unit of a power supply device and comprises

obtaining a measure of the load voltage as a voltage at the converter,

obtaining an estimate of a voltage drop between the converter (30) and the load,

obtaining a reference voltage corresponding to a desired load voltage,

adjusting either the reference voltage or the load voltage measure with the voltage of the estimated voltage drop,

comparing, after the adjusting, the load voltage measure with the reference voltage for obtaining an error signal, and

controlling the converter to provide the load voltage based on the error signal.

The object is according to a third aspect achieved by a computer program for controlling a converter supplying power to a load.

The computer program comprises computer program code which when run in a converter control unit of a power supply device causes the converter control unit to:

obtain a measure of the load voltage as a voltage at the converter,

obtain an estimate of a voltage drop between the converter and the load,

obtain a reference voltage corresponding to a desired load voltage,

adjust either the reference voltage or the load voltage measure with the voltage of the estimated voltage drop,

compare, after the adjustment, the load voltage measure with the reference voltage for obtaining an error signal, and

control the converter to provide the load voltage based on the error signal.

The object is according to a fourth aspect furthermore achieved through a computer program product for controlling a converter supplying power to a load. The computer program product is provided on a data carrier and comprises the computer program code according to the third aspect.

There are several advantages associated with the aspects. It simplifies control, since there is no need for measuring load voltages. Thereby measurement connections that are used for receiving these load voltage measurements are no longer needed, which in thus allows components comprising the power supply to be made smaller. Furthermore, if the device is provided on a circuit board, father space is saved in that conductors on the circuit board carrying the load voltage measurements may also be omitted.

According to one variation of the first aspect, the converter control unit, if adjusting the reference voltage is configured to raise the reference voltage using the voltage of the estimated voltage drop and if adjusting the load voltage measure is configured to lower the load voltage measure using the voltage of the estimated load voltage drop

According to a corresponding variation of the second aspect, an adjustment of the reference voltage comprises raising the reference voltage using the voltage of the estimated voltage drop and an adjustment of the load voltage measure comprises lowering the load voltage measure using the voltage of the estimated load voltage drop.

According to another variation of the first aspect, then the converter control unit determines the estimated voltage drop as the current output by the converter times the resistive loss between the converter and the load.

According to a corresponding variation of the second aspect, the obtaining of an estimated voltage drop involves determining the estimated voltage drop as the current output by the converter times the resistive loss between the converter and the load

According to a further variation of the first aspect, the converter control unit is further arranged to low pass filter the current before it is used in any adjustment.

According to a corresponding variation of the third aspect, the method further comprises low pass filtering the current before it is used in any adjustment.

The cut off frequency of the low pass filtering may be lower than the switching frequency of the converter. It may more particularly be 1/10 of the switching frequency or lower.

The control may furthermore be digital where the output current is obtained as current samples sampled at a current sampling frequency and the load voltage measure are obtained as voltage samples sampled with a voltage sampling frequency,

In a further variation of the first aspect and the second aspect, the current sampling frequency may be different than the voltage sampling frequency. It may with advantage be lower than the voltage sampling frequency.

The power supply device may further more comprise the converter. In this case the converter and converter control unit may furthermore be provided in the same component.

It should be emphasized that the term “comprises/comprising” when used in this specification is taken to specify the presence of stated features, integers, steps or components, but does not preclude the presence or addition of one or more other features, integers, steps, components or groups thereof.

### BRIEF DESCRIPTION OF THE DRAWINGS

Embodiments of the invention will now be explained in detail, by way of example only, with reference to the accompanying figures, in which:

FIG. 1 is a schematic of an intermediate Bus Architecture power system comprising a number of power supply devices;

FIG. 2 is a schematic of a power supply device that may be provided in the IBA power system of FIG. 1;

FIG. 3 shows an alternative realization of the power supply device

FIG. 4 shows a flow chart of method steps used for controlling a converter supplying power to a load according to a first embodiment;

FIG. 5 shows a flow chart of method steps used for controlling a converter supplying power to a load according to a second embodiment;

FIG. 6 shows a variation of the power supply device in FIG. 2;

FIG. 7 shows a flow chart of method steps used for controlling a converter supplying power to a load according to a third embodiment; and

FIG. 8 shows changes in measured and estimated load voltage for a load current pulse in the power supply device.

### DETAILED DESCRIPTION

The invention is concerned with a power supply device. A power supply device may with advantage be provided as a part of an Intermediate Bus Architecture (IBA). In the following it will be described in relation to this environment. It should however be realized that the power supply device is in no way limited to this particular environment but may be used in any type of power supply environment.

IBA power supply systems are of interest to use for supplying power to loads such as high-performance Ultra-Large Scale Integration (ULSI) circuits (e.g. processors, application-specific integrated circuits (ASICs) and Field-Programmable Gate Arrays (FPGAs)). These circuits may furthermore be provided in communication networks, such as telecommunication networks, where the communication networks may furthermore be wireless communication networks such as Long Term Evolution (LTE) or Wideband Code Division Multiple Access (WCDMA) communication networks. The loads may for instance be provided as circuits in a base station, often termed nodeB or enodeB, a Gateway GPRS Support Node (GGSN) or a Serving GPRS Support nodes (SGSN), where GPRS in an acronym for Global Packet Radio Access.

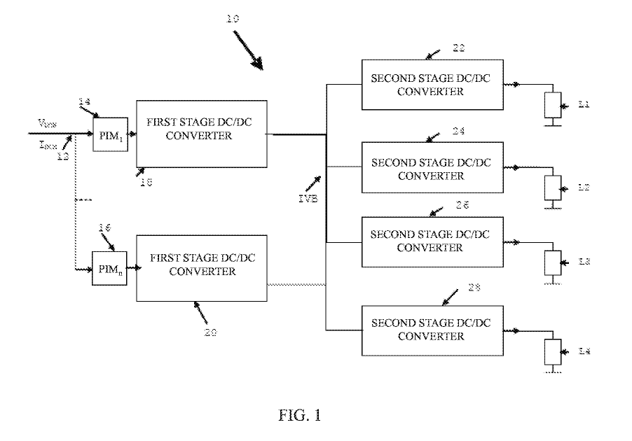

FIG. 1 is a schematic of one such IBA power system 10. The IBA power system 10 in FIG. 1 is a two-stage power distribution network comprising a number n (where n ≧1) of parallel-coupled first stage DC/DC converters 18 and 20, whose outputs are connected via an intermediate voltage bus (IVB) to a number K (where K≧1) of second stage DC/DC converters 22, 24, 26 and 28. The second stage converters are here examples of power supply devices where aspects of the invention may be implemented The first stage converters 18 and 20 are connected to an input power bus at a voltage VDCH, which is typically at a voltage VDCH between 36-75 V, 18-36 V or 18-60 V. Each first stage converter may furthermore be connected to the input power bus via an optional corresponding filtering unit 14 and 16. Such a filtering unit is sometimes referred to as a Power Input Module (PIM). The PIMs (PIM1) 14 and (PIMn) 16 are thus connected to the input power bus and each delivers an OR-ed and filtered mains voltage to the corresponding first stage converter.

Each of the first stage DC/DC converters 18 and 20 is preferably an isolated DC/DC converter. A first stage converter is furthermore often referred to as an Intermediate Bus Converter (IBC). An IBA power supply system having such first stage DC/DC converters or IBCs has the advantage of being efficient and cost-effective to manufacture because isolation from the input power bus, which generally requires the use of relatively costly components including a transformer, is provided by a relatively small number of converters (or, where n=1, by a single converter). Alternatively, the IBCs may be non-isolated from the input power bus. The IBCs are preferably each implemented in the efficient form of a Switched Mode Power Supply (SMPS), which can be fully regulated or line regulated to convert the input power bus voltage to a lower intermediate bus voltage VIB on the IVB. The IBCs may also be fixed ratio converters.

In general, two or more of the IBCs 18 and 20 may be provided in a current sharing arrangement such that they supply power in parallel to second stage DC-to-DC converters.

As shown in FIG. 1, the IBCs are connected via the IVB to the inputs of a number of second stage DC/DC converters 22, 24, 26 and 28. Each of the plurality of second stage DC/DC converters may be a non-isolated POL regulator in the form of an SMPS. However, a second stage DC/DC converter is not limited to such a converter and may alternatively be a non-switched converter, such as a Low Drop Out (LDO) (linear) regulator. Furthermore, some or all of the second stage DC/DC converters may alternatively be isolated but where isolation is provided by the IBCs, it is advantageous from a cost perspective for the second stage DC/DC converters to be non-isolated. Each POL 22, 24, 26 and 28 delivers a regulated output voltage o its load L1, L2, L3 and L4, respectively.

The IBCs and the POLs may have any type of suitable topology and be of any suitably type. They may thus be Buck, Boost, Buck-Boost, etc.

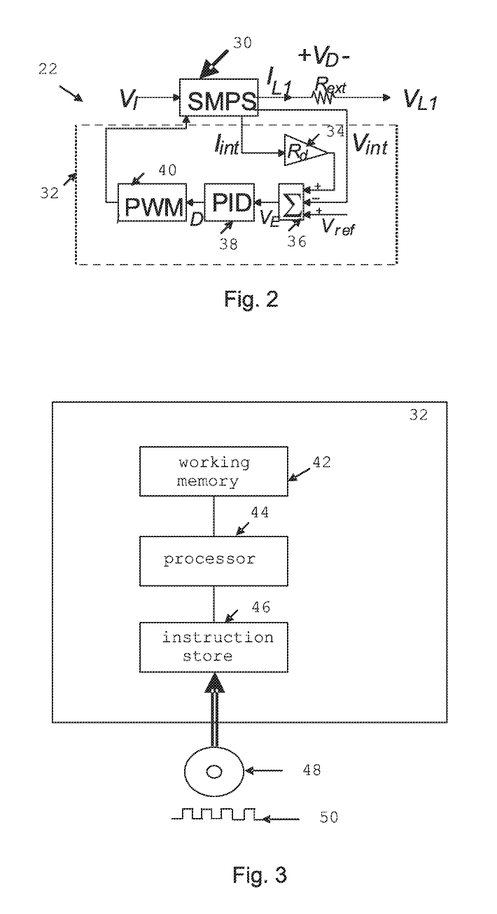

FIG. 2 is a schematic view of one way of realizing a power supply device, which power supply device may be one of the above described POLs and in tis example the first Pol 22 connected to the first load L1. Alternatively it may be an IBC.

The power supply device 22 comprises a converter 30, which thus may be an SMPS comprising a number of switches. The converter 30 receives an input voltage V₁ and supplies an output current I_{L1} to a load via an external resistance Rₑₓₜ over which there is voltage drop VD. In order to control the converter 30 there is furthermore a converter control unit 32 that receives measurements for the converter 30 and provides a control signal for controlling the converter 30.

In the realization in FIG. 2 the converter control unit 32 comprises an error signal forming element 36, which has a first input connected to the converter 30 via an amplifying element 34 having an amplification Rd, a second input connected directly to the converter 30 and a third input on which it receives a reference voltage V_{ref}. The error signal forming element 36, which may be realized as a summing element, has an output connected to the input of a regulator 38, which is a PID regulator. On the regulator output, there is provided an output signal, which output signal is an error signal V_{E}. The regulator 38 in turn has an output with a signal D output to a pulse width modulation (PWM) element 40, which in turn is connected to the converter 30 for controlling it.

FIG. 3 shows an alternative realization of the converter control unit 32. It comprises a processor 44, a working memory 42 and an instruction store 46 storing computer-readable instructions which, when executed by the processor 44 cause the processor to perform the processing operations hereinafter described to control the converter. The instruction store 46 may comprise a ROM which is pre-loaded with the computer-readable instructions. Alternatively, the instruction store 46 may comprise a RAM or similar type of memory, and the computer readable instructions can be input thereto from a computer program product, such as a computer-readable storage medium 48 such as a CD-ROM, etc. or a computer-readable signal 50 carrying the computer-readable instructions.

As described initially, the conventional way of controlling the converter 30 is to measure the voltage at the load and use this in the control. This voltage may be hard to measure because the load may be distributed and some of the load elements may also be at locations where measurements are hard to make. Furthermore it is possible that the converter and converter control unit are provided as a common component. In this case these measurements require the use of dedicated galvanic connection points, such as contact pins and contact pads on the component. There are therefore space saving possibilities if these connection points are removed. The invention is directed towards improving on both these situations.

In such load voltage measurements, the contact points would furthermore be connected to two sense lines. If the power supply device is provided on a circuit board, these lines will also occupy space. It may also be hard to determine which points to sense. In some cases with long sense wires the inductance in those lines may affect the control loop formed by the amplifying element 34, the error signal forming element 36, the regulator 38 and the PWM element 40 negatively since that inductance is a part of the loop.

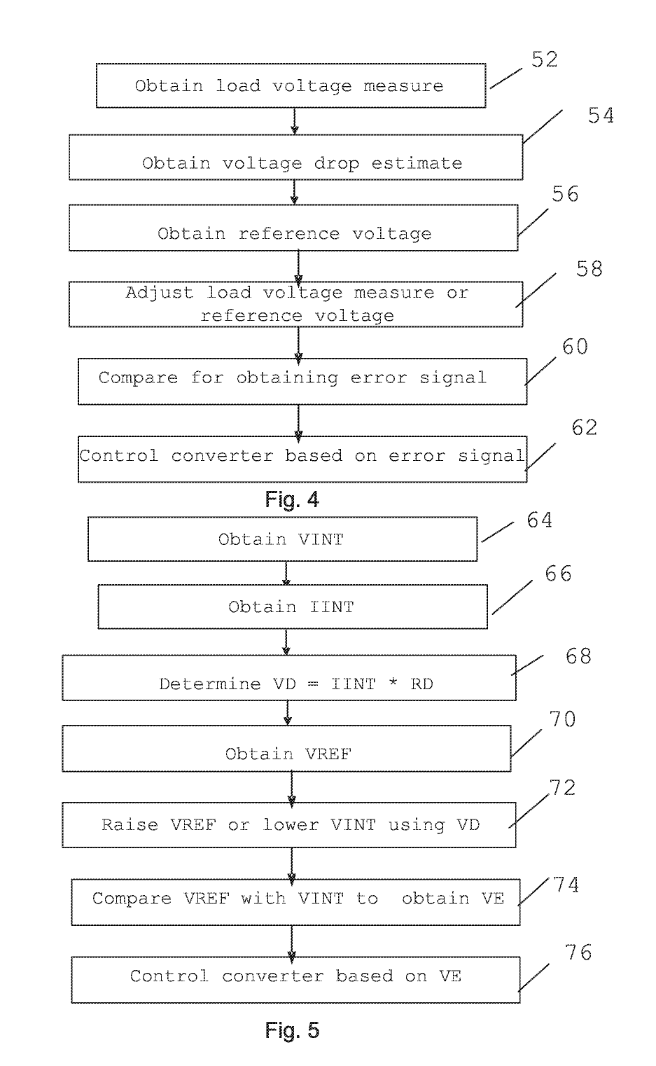

Now a first embodiment will be described in relation to FIGS. 2 and 4, where FIG. 4 shows a flow chart of a number of method steps in a method for controlling the converter 30 supplying power to a load.

The converter 30 provides an output voltage and an output current I_{L1} that is supplied to the load via the external resistance Rₑₓₜ. The actual voltage V_{L1} of the load is then the difference between the output voltage and the voltage drop VD over the external resistance Rₑₓₜ.

According to aspects of the invention droop voltage control is used. This means that the load voltage V_{L1} is not measured. Instead a measure of the load voltage V_{L1} is used. The voltage used as a measure may be an internal voltage Vᵢₙₜ of the converter 30, for instance the voltage at the output of the converter 30 at which power is delivered to the load. Even when the voltage of the voltage measure is the output voltage, it is possible to obtain this internally in the component without the use of external galvanic contact points In aspects of the invention also an internal current Iᵢₙₜ may be used, which may be the current output from the converter 30 to the load. This current may be the current delivered at the output of the converter 30. Also the current may be obtained internally in the component without the use of external contact points.

The operation of the method may therefore be started through the error forming element 36 of the converter control unit 32 obtaining a measure of the load voltage V_{L1} as a voltage at the converter 30, step 52. It may obtain this measure through receiving the above-mentioned internal voltage from the converter 30. The error forming element 36 may also obtain a measure of the voltage drop VD across the external resistance Rₑₓₜ, step 54. As a non-limiting example the measure may be obtained through the converter control unit 32 receiving the abovementioned Internal current Iᵢₙₜ and multiplying it with an amplification or gain Rd representing the resistive loss between the power delivery output of the converter 30 and the load L1. Finally the error forming element 36 obtains a reference voltage V_{ref} corresponding to a desired load voltage, step 56. The reference voltage may be in the range 0.5-5 V, if the power supply device is a POL and in the range 5-12 V if the power supply device is an IBC. The reference voltage may in this case with advantage also be fixed.

Thereafter the error forming element 36 forms an error signal V_{E} based on the load voltage measure Vᵢₙₜ, the voltage drop estimate and the reference voltage V_{ref}. An error signal V_{E} is normally obtained through determining the difference between the desired load voltage and the reference voltage.

The forming of the error signal does in this case involve adjusting either load voltage measure or the reference voltage V_{ref} with the voltage of the estimated voltage drop, step 36. As can be seen in FIG. 2, the voltage drop estimate may be added to the reference voltage V_{ref} or it may be subtracted from the load voltage measure Vᵢₙₜ.

After one of the load voltage measure Vᵢₙₜ and the reference voltage V_{ref} has been adjusted, the error forming element 36 compares the load voltage measure Vᵢₙₜ with the reference voltage V_{ref} for obtaining the error signal V_{E}, step 60.

The error signal is thereafter used by the converter control unit 32 in controlling the converter 30 to provide the load voltage, step 62.

The use of the error signal may involve the regulator 38 performing regulation on the error signal V_{E}. The regulation may be proportional regulation. It may also be integrating regulation or derivative regulation. It may also be a combination of two or more of the different types of regulation. An output signal in the form of a switch duty cycle D may in this specific example then be output from the regulator 38 to the PWM element 40, which then translates the switch duty cycle D into switch pulses Qi, with that duty cycle. The switch pulses Qi are then applied to the switching elements of the converter 30 in order to obtain the correct output voltage V_{L1}. The duty cycle thereby defines a switching frequency with which the switches of the converter 30 are switched.

It can be seen that through this type of control no load voltage measurement needs to be made and consequently also the corresponding component contact points may be omitted.

Now a second embodiment will be described with reference being made to FIG. 5, which also shows a flow chart of a number of method steps in a method for controlling the converter 30 supplying power to the load.

Also in this embodiment the method starts with the error forming element 36 obtaining the internal voltage Vᵢₙₜ corresponding to the converter output voltage, step 64. It may thus receive the internal voltage Vᵢₙₜ from the converter 30.

The converter control element 32 also obtains the internal current Vᵢₙₜ, i.e. a value of the current supplied to the load L1, step 66. This current is received by the amplifying element 34. Thereafter the converter control unit 32 determines the estimated voltage drop VD. This is done through determining the estimated voltage drop as the current Iᵢₙₜ output by the converter 30 times the resistive loss RD between the converter and the load, step 68. As can be seen in FIG. 2, the estimated voltage drop is obtained through the amplifying element 34 amplifying the current Iᵢₙₜ with the resistance Rd, where the result of the amplification is then sent to the error forming element 36 as the voltage drop measure.

The error forming element thereby obtains or receives the voltage drop estimate. Finally the error forming element also obtains or receives the reference voltage V_{ref} , step 70.

Thereafter the error forming element 36 either raises the reference voltage V_{ref} using the voltage of the estimated voltage drop VD or lowers the load voltage measure Vᵢₙₜ using the voltage of the estimated load voltage drop VD, step 72.

It can be seen that the error voltage may generally be obtained according to the equation

V_{E}=V_{ref}+IᵢₙₜR_{d}−Vᵢₙₜ

By choosing R_{d}=Rₑₓₜ the load voltage V_{L1} will ideally (at steady state) be independent of the load current and equal to V_{ref}.

In order to obtain the error signal the error signal forming element 36 then compares, after having performed the adjustment, the load voltage measure Vᵢₙₜ with the reference voltage, step 74.

The error signal V_{E} is thereafter used by the converter control unit 32 in controlling the converter 30 to provide the load voltage V_{L1} based on the error signal V_{E}, step 76.

The error signal V_{E} may in this regard be used in the control in the same way as was described in relation to the first embodiment.

It is possible that the converter output voltage is unstable with ringing. A third embodiment is directed towards addressing this problem.

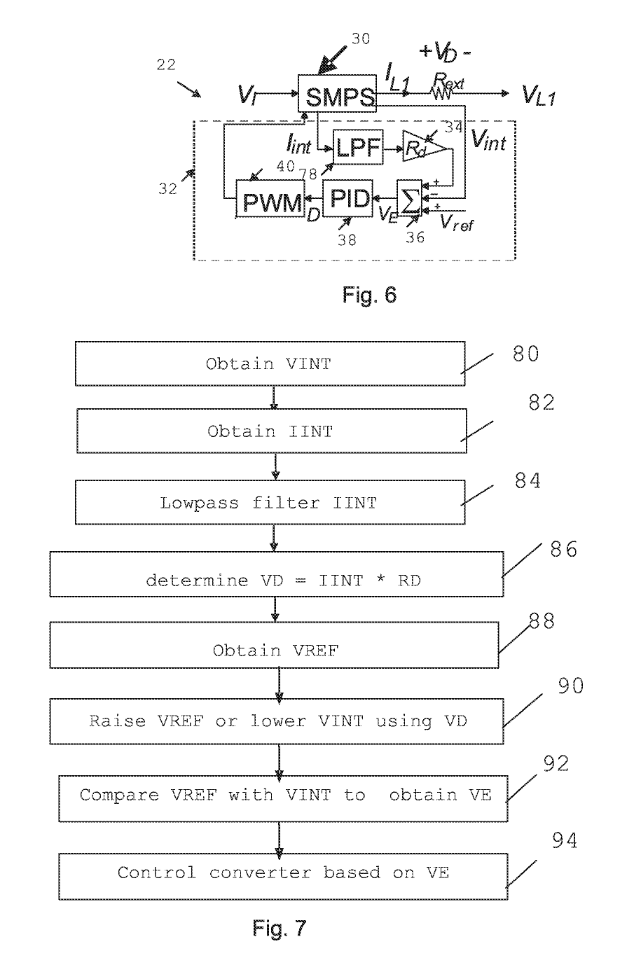

FIG. 6 schematically shows a power control device 22, i.e. a combination of converter 30 and converter control unit 32, according to this third embodiment. The difference from the power control device of FIG. 2 is that there is a low pass filter 78 between the converter 30 and the amplifying element 34. The low pass filter 78 receives the internal current Iᵢₙₜ and supplies a low pass filtered internal current to the amplifying element 32. The cut-off frequency of the low pass filter is lower than the switching frequency of the converter and may with advantage be 1/10 of the switching frequency or lower. The low pass filter can be a simple moving average filter of low order or a first order recursive IIR filter with low bandwidth. It should be realized that the low pass filter placing may be varied. As an alternative, the low pass filter 78 may be connected between the amplifying element 34 and the error forming element 36.

The operation according to the third embodiment is outlined a flow chart in FIG. 7 and is the following:

The error forming element 36 again obtains the internal voltage Vᵢₙₜ corresponding to the converter output voltage, step 80. It may thus receive the internal voltage from the converter 30.

The converter control unit 32 also obtains the internal current Iᵢₙₜ, step 82. However, in this case the low pass filter 78 receives the internal current hint from the converter 30. The low pass filter 78 then filters the internal current Iᵢₙₜ, step 84, and supplies the filtered internal current to the amplifying element 34, which estimates the voltage drop VD. This is done through determining the estimate voltage drop as the filtered internal current times the resistive loss RD between the converter 30 and the load L1, step 86. As can be seen in FIG. 6, the estimated voltage drop is obtained through the amplifying element 34 amplifying the filtered current with the resistance Rd, where the result of the amplification is then sent to the error forming element 36 as the voltage drop measure.

The error forming element 36 thereby obtains or receives the voltage drop estimate for use in forming the error signal V_{E}. The error forming element also obtains or receives the reference voltage V_{ref}, step 88.

Thereafter the error forming element 36 either raises the reference voltage V_{ref} using the voltage of the estimated voltage drop VD or lowers the load voltage measure Vᵢₙₜ using the voltage of the estimated load voltage drop VD, step 90.

After having performed this adjustment, the error signal forming element 36 then compares the load voltage measure Vᵢₙₜ with the reference voltage V_{ref} in order to obtain the error signal V_{E}, step 92.

The error signal is thereafter used by the converter control unit 32 in controlling the converter 30 to provide the load voltage based on the error signal V_{E}, step 94.

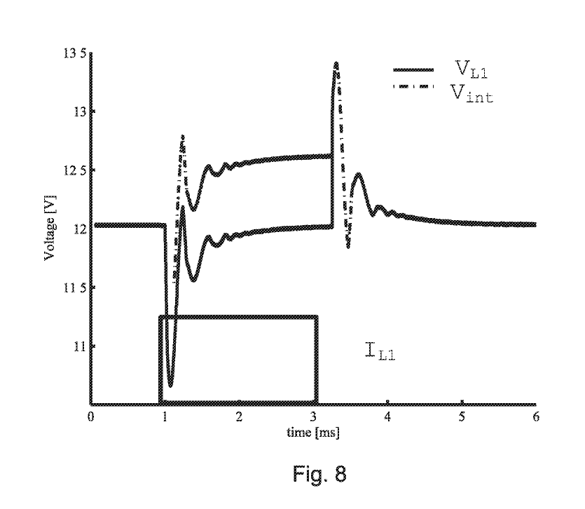

The new type of control operates well in comparison with traditional control based on load voltage measurements. This can be seen in FIG. 8, which shows the load voltage measure Vᵢₙₜ compared with a corresponding measured load voltage V_{L1} for a current pulse IL.

The control may be analogue. As an alternative it may be digital, i.e. using sampling of the current and the voltage. The control may thus be digital where the converter control unit 32 obtains the internal current Iᵢₙₜ as current as samples sampled at a current sampling frequency and the load voltage measure Vᵢₙₜ as voltage samples sampled with a voltage sampling frequency, In this case the current sampling frequency is with advantage different than the voltage sampling frequency. The current sampling frequency may more particularly be lower than the voltage sampling frequency.

The converter output voltage is with advantage below 400 V and may be in the range of 0.5-400 V. Above, the reference voltage was described as being fixed. It may as an alternative be variable depending on the load. The reference voltage may for instance be varied if the power supply device is supplying power to a Central Processing Unit (CPU), in which case it is a so-called Voltage Regulation Module. It may also be varied in an IBC, where a Dynamic Bus Voltage is provided. In this case the reference voltage may as an example vary between 8-14 V.

It should also be realized that the converter may be any type of converter. It may thus be an AC/DC converter, a DC/DC converter, a DC/AC converter or an AC/AC converter.

The converter control unit may further be considered to comprise comprising means for obtaining a measure of the load voltage as a voltage at the converter means for obtaining an estimate of a voltage drop between the converter and the load,
means for obtaining a reference voltage corresponding to a desired load voltage,
means for adjusting either the reference voltage or the load voltage measure with the voltage of the estimated voltage drop,
means for comparing, after the adjustment, the load voltage measure with the reference voltage for obtaining an error signal, and
means for controlling the converter to provide the load voltage based on the error signal.

The means for obtaining a measure of the load voltage, the means for obtaining a reference voltage corresponding to a desired load voltage, the means for adjusting either the reference voltage or the load voltage measure with the voltage of the estimated voltage drop, and the means for comparing, after the adjustment, the load voltage measure with the reference voltage may here be implemented through the error forming element and the means for controlling the converter may be implemented through the regulator and PWM element.

The means for adjusting either the reference voltage or the load voltage measure may further be implemented as means for raising the reference voltage using the voltage of the estimated voltage drop or means for lowering the load voltage measure using the voltage of the estimated load voltage drop.

The converter control unit may further be considered to comprise means for determining the estimated voltage drop as the current output by the converter times the resistive loss between the converter and the load. This may be implemented through the low pass filter.

The converter control unit may further be considered to comprise means for obtaining the output current as current samples sampled at a current sampling frequency and means for obtaining the load voltage measure as voltage samples sampled with a voltage sampling frequency, where the current sampling frequency is different than the voltage sampling frequency.

While the invention has been described in connection with what is presently considered to be most practical and preferred embodiments, it is to be understood that the invention is not to be limited to the disclosed embodiments, but on the contrary, is intended to cover various modifications and equivalent arrangements. Therefore the invention is only to be limited by the following claims.

1.-19. (canceled)

20. A converter control unit for controlling a power supply device including a converter that provides power to a load, comprising:
a processor; and
a memory including computer program code, wherein said processor, said memory, and said computer program code are collectively operable to:
obtain a load voltage measure from said converter representing a load voltage of said load;
obtain an estimate of a voltage drop between said converter and said load;
obtain a reference voltage corresponding to a desired load voltage;
adjust said reference voltage or said load voltage measure with said estimate of said voltage drop;
compare, after an adjustment, said load voltage measure with said reference voltage to acquire an error signal; and
control said converter to provide said load voltage based on said error signal.

21. The converter control unit as recited in claim 20 wherein said memory and said computer program code are further configured to, with said processor cause said converter control unit to adjust said reference voltage by raising said reference voltage with said estimate of said voltage drop or adjust said load voltage measure by lowering said load voltage measure with said estimate of said voltage drop.

22. The converter control unit as recited in claim 20 wherein said memory and said computer program code are further configured to, with said processor cause said converter control unit to obtain an internal current of said converter and obtain said estimate of said voltage drop by multiplying said internal current with a resistive loss between said converter and said load.

23. The converter control unit as recited in claim 22 wherein said memory and said computer program code are further configured to, with said processor cause said converter control unit to filter said internal current of said converter with a low pass filter.

24. The converter control unit as recited in claim 23 wherein a cut off frequency of said low pass filter is lower than a switching frequency of said converter.

25. The converter control unit as recited in claim 24 wherein said cut off frequency of said low pass filter is ten percent or less than said switching frequency of said converter.

26. The converter control unit as recited in claim 22 wherein said memory and said computer program code are further configured to, with said processor cause said converter control unit to obtain said internal current as current samples sampled at a current sampling frequency and obtain said load voltage measure as voltage samples sampled with a voltage sampling frequency, wherein said current sampling frequency is different than said voltage sampling frequency.

27. The converter control unit as recited in claim 26 wherein said current sampling frequency is lower than said voltage sampling frequency.

28. A method for controlling a power supply device including a converter that provides power to a load, comprising:
obtaining a load voltage measure from said converter representing a load voltage of said load;
obtaining an estimate of a voltage drop between said converter and said load;
obtaining a reference voltage corresponding to a desired load voltage;
adjusting said reference voltage or said load voltage measure with said estimate of said voltage drop;
comparing, after an adjustment, said load voltage measure with said reference voltage to acquire an error signal; and
controlling said converter to provide said load voltage based on said error signal.

29. The method as recited in claim 28 wherein said adjusting further comprises raising said reference voltage with said estimate of said voltage drop or lowering said load voltage measure with said estimate of said voltage drop.

30. The method as recited in claim 28 further comprising obtaining an internal current of said converter and wherein obtaining said estimate of said voltage drop comprises multiplying said internal current with a resistive loss between said converter and said load.

31. The method as recited in claim 30 further comprising filtering said internal current of said converter with a low pass filter.

32. The method as recited in claim 31 wherein a cut off frequency of said low pass filter is lower than a switching frequency of said converter.

33. The method as recited in claim 32 wherein said cut off frequency of said low pass filter is ten percent or less than said switching frequency of said converter.

34. The method as recited in claim 30 wherein obtaining said internal current comprises obtaining current samples sampled at a current sampling frequency and obtaining said load voltage measure comprises obtaining voltage samples sampled with a voltage sampling frequency, wherein said current sampling frequency is different than said voltage sampling frequency.

35. The method as recited in claim 34 wherein said current sampling frequency is lower than said voltage sampling frequency.

36. A computer program product comprising a program code stored in a non-transitory computer readable medium, operable to cause an apparatus comprising a processor and a memory to:
obtain a load voltage measure from a converter representing a load voltage of a load coupled to said converter;
obtain an estimate of a voltage drop between said converter and said load;
obtain a reference voltage corresponding to a desired load voltage;
adjust said reference voltage or said load voltage measure with said estimate of said voltage drop;
compare, after an adjustment, said load voltage measure with said reference voltage to acquire an error signal; and
control said converter to provide said load voltage based on said error signal.

37. The computer program product as recited in claim 36 wherein said program code stored in said non-transitory computer readable medium is operable to cause said apparatus to adjust said reference voltage by raising said reference voltage with said estimate of said voltage drop or adjust said load voltage measure by lowering said load voltage measure with said estimate of said voltage drop.

38. The computer program product as recited in claim 36 wherein said program code stored in said non-transitory computer readable medium is operable to cause said apparatus to obtain an internal current of said converter and obtain said estimate of said voltage drop by multiplying said internal current with a resistive loss between said converter and said load.

39. The computer program product as recited in claim 38 wherein said program code stored in said non-transitory computer readable medium is operable to cause said apparatus to obtain said internal current as current samples sampled at a current sampling frequency and obtain said load voltage measure as voltage samples sampled with a voltage sampling frequency, wherein said current sampling frequency is different than said voltage sampling frequency.
